(19) United States
(12) Patent Application Publication
(10) Pub. No.: US 2024/0258711 A1
(43) Pub. Date: Aug. 1, 2024

(54) RADIATION ARRAY GROUP, RADIATION ARRAY AND DUAL-BEAM ANTENNA

(71) Applicants: PROSE TECHNOLOGIES (SUZHOU) CO., LTD., Suzhou (CN); PROSE TECHNOLOGIES LLC, Mount Olive, NJ (US)

(72) Inventors: Zhongcao YANG, Suzhou (CN); Guoqun CHEN, Suzhou (CN); Huirong GU, Suzhou (CN); Shengguang WANG, Suzhou (CN)

(21) Appl. No.: 18/630,193

(22) Filed: Apr. 9, 2024

Related U.S. Application Data
(63) Continuation of application No. PCT/CN2022/104496, filed on Jul. 8, 2022.

(30) Foreign Application Priority Data
Dec. 27, 2021 (CN) 202111611997.0

(51) Int. Cl. H01Q 21/06; H01Q 1/24; H01Q 15/14

(52) U.S. Cl. CPC H01Q 21/061; H01Q 1/246; H01Q 15/14

(57) ABSTRACT

A radiation array group for a dual-beam antenna includes a first radiation array and a second radiation array. The first radiation array is configured to form a first beam. The second radiation array is configured to form a second beam. Either one of the first radiation array and the second radiation array includes at least two radiating element rows. Each radiating element row of the at least two radiating element rows includes two radiating elements. The at least two radiating element rows are not always aligned with each other.

### CROSS-REFERENCES TO RELATED APPLICATIONS

This application is a continuation of International Application No. PCT/CN2022/104496, filed on Jul. 8, 2022, which claims priority to Chinese Patent Application No. 202111611997.0, filed on Dec. 27, 2021, the entire contents of both of which are incorporated herein by reference.

### TECHNICAL FIELD

The present disclosure generally relates to the communication technology field and, more particularly, to a radiation array group, a radiation array forming the radiation array group, and a dual-beam antenna.

### BACKGROUND

With the continuous development of mobile communication technology, mobile communication networks are continuously upgraded. As critical equipment of the mobile communication networks, a performance indicator and a function of a base station antenna are continuously improved.

Compared to an existing 65-degree three-sector antenna, beam-splitting technology can provide better network coverage and capacity. Thus, the beam-splitting technology is adopted by more operators. With the development of beam-splitting antennas, those skilled in the art provide the following technical solutions which provide poor satisfaction.

A core of a dual-beam antenna using Butler technology is developing, for a 90-degree coupler, Butler matrixes for branching two input signals into three or four output signals. An isolation characteristic of a port of the coupler can be used to share a radiating element to split the dual beam. In practical engineering, since unit matching is difficult in a tightly coupled status, and the isolation for the coupler itself is limited, the isolation is poor for beams at two ports with the same polarization and is difficult to improve. In addition, since the radiating element is shared, a phase difference between two neighboring radiating elements is constant within a bandwidth range of the Butler matrix. ±90 degrees are commonly used, which leads to a significant difference in horizontal beam pointing directions and horizontal beam widths within the broadband range and is unfavorable for the network coverage within the broadband range.

In another technology, feeding networks and radiating elements are independent of each other. Thus, although an antenna size is slightly sacrificed, a fixed physical beam pointing direction by tilting a reflector is obtained. Thus, the beam isolation and horizontal broadband coverage are significantly improved. In addition, since the independent radiating elements are used, more arrays are added compared to the solution using the Butler technology, which results in increased costs. Based on this, an improvement direction is to use power dividers or couplers to allow the left and right beams to share the radiating elements in the center column to reduce the radiating elements and the antenna size. However, since the radiating elements in the center column have the corresponding power consumption for each beam at left and right, the antenna gain loss is severe, and the power consumption is high.

### SUMMARY

A first aspect of the present disclosure provide a radiation array group for a dual-beam antenna, including a first radiation array and a second radiation array. The first radiation array is configured to form a first beam. The second radiation array is configured to form a second beam. Either one of the first radiation array and the second radiation array includes at least two radiating element rows. Each radiating element row of the at least two radiating element rows includes two radiating elements. The at least two radiating element rows are not always aligned with each other.

Further, a second aspect of the present disclosure provides a radiation array, including at least one first radiating element row and at least one second radiating element row. The first radiating element row includes a first element and a second element arranged in a row along a first direction. The second radiating element row includes a third element and a fourth element arranged in a row along the first direction. The at least one first radiating element row and the at least one second radiating element row are arranged along a second direction perpendicular to the first direction. A center projection of the first element, a center projection of the third element, a center projection of the second element, and a center projection of a fourth element are arranged in sequence on a plane perpendicular to the second direction.

In addition, a third aspect of the present disclosure provides a dual-beam antenna, including a radiation array group according to the first aspect of the present disclosure or a radiation array according to the second aspect of the present disclosure; and a power divider connected to the radiation array group.

### BRIEF DESCRIPTION OF THE DRAWINGS

FIG. 1 is a schematic structural diagram of a radiation array group according to some embodiments of the present disclosure.

FIG. 2 is a schematic structural diagram of a radiation array group according to some embodiments of the present disclosure.

FIG. 3 is a schematic structural diagram of a radiation array according to some embodiments of the present disclosure.

FIG. 4 is a schematic structural diagram of a radiation array group according to some embodiments of the present disclosure.

FIG. 5 is a schematic structural diagram of a radiation array group according to some embodiments of the present disclosure.

FIG. 6 is a schematic structural diagram of a radiation array group according to some embodiments of the present disclosure.

FIG. 7 is a schematic structural diagram of a radiation array group according to some embodiments of the present disclosure.

FIG. 8 is a schematic diagram showing wiring of a radiation array group in FIG. 6 according to some embodiments of the present disclosure.

### DETAILED DESCRIPTION OF THE EMBODIMENTS

Embodiments of the present disclosure are described in connection with the accompanying drawings of embodiments of the present disclosure. The accompanying drawings show embodiments of the present disclosure through examples. Exemplary embodiments are not intended to exhaust all embodiments of the present disclosure. Without departing from the scope of the present disclosure, other embodiments can be used, and structural and logical modifications can be made. Thus, the following description is not limiting, and the scope of the present disclosure is subject to the appended claims.

Technical problems in the field often include that the number of radiating elements used in the existing dual-beam antenna is too many and causes high cost, and the tight coupling causes low radiation efficiency and severe gain loss for the dual-beam antenna with high power consumption.

Embodiments of the present disclosure provide a new dual-beam antenna design that solves at least part of the above problem. In the dual-beam antenna, a distance between two neighboring radiating elements of a same row of each radiation array of the radiation array group can be increased, and radiating elements of different rows can be staggered to reduce the number of radiating elements and improve the radiation efficiency.

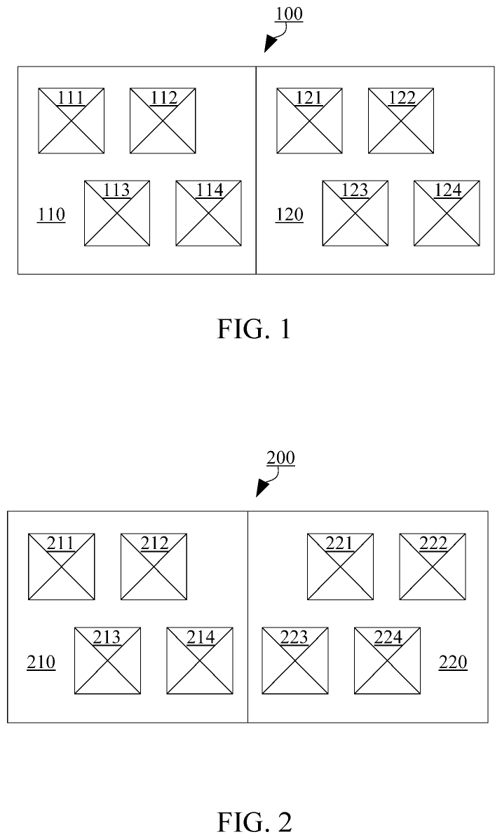

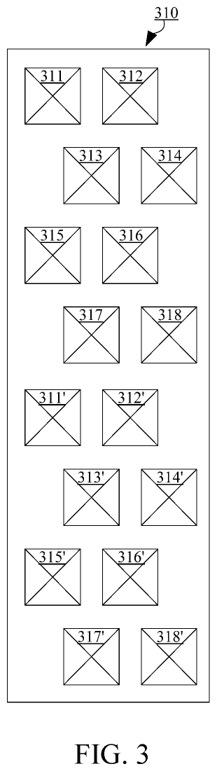

The radiation array group or the radiation array as a simplest structure of the present disclosure is described in connection with FIG. 1, FIG. 2, and FIG. 3.

FIG. 1 is a schematic structural diagram of a radiation array group 100 according to some embodiments of the present disclosure. As shown in FIG. 1, the radiation array 100 applied to a dual-beam antenna of the present disclosure includes a first radiation array 110 forming a first beam and a second radiation array 120 forming a second beam. The first radiation array 110 or the second radiation array 120 includes two radiating element rows. Each radiating element row of the two radiating element rows includes two radiating elements. The two radiating element rows may not always be aligned with each other. In some embodiments, the first radiation array 110 of FIG. 1 includes two radiating element rows. A first radiating element row includes a radiating element 111 and a radiating element 112. A second radiating element row includes a radiating element 113 and a radiating element 114. Correspondingly, the second radiating element array 120 of FIG. 1 includes two radiating element rows. A first radiating element row includes a radiating element 121 and a radiating element 122. A second radiating element row includes a radiating element 123 and a radiating element 124.

As shown in FIG. 1, the first radiating element row and the second radiating element row are not always aligned with each other. That is, for the first radiating element array 110, the first radiating element 111 of the first row is staggered and not aligned with the first radiating element 113 of the second row. Correspondingly, the second radiating element 112 of the first row and the second radiating element 114 of the second row are also staggered and not aligned with each other. Similarly, for the second radiation array 120, the first radiating element 121 of the first row and the first radiating element 123 of the second row are staggered and not aligned with each other. Correspondingly, the second radiating element 122 of the first row and the second radiating element 124 of the second row are staggered and not aligned with each other. In addition, as shown in FIG. 1, the first radiation array 110 and the second radiation array 120 have the same structure.

FIG. 2 is a schematic structural diagram of a radiation array group 200 according to some embodiments of the present disclosure. As shown in FIG. 2, the radiation array group 200 applied to the dual-beam antenna of the present disclosure includes a first radiation array 210 forming a first beam and a second radiation array 220 forming a second beam. The first radiation array 210 and the second radiation array 220 each include two radiating element rows. Each radiating element row includes two radiating elements. The two radiating element rows are not always aligned with each other. In some embodiments, the first radiation array 210 in FIG. 2 includes two radiating element rows. The first radiating element row includes a radiating element 211 and a radiating element 212, and the second radiating element row includes a radiating element 213 and a radiating element 214. Correspondingly, the second radiation array 220 in FIG. 2 includes two radiating element rows. The first radiating element row includes a radiating element 221 and a radiating element 222, and the second radiating element row includes a radiating element 223 and a radiating element 224.

As shown in FIG. 2, the first radiating element row and the second radiating element row are not always aligned with each other. That is, for the first radiation array 210, the first radiating element 211 of the first row and the first radiating element 213 of the second row are staggered and not aligned. Correspondingly, the second radiating element 212 of the first row and the second radiating element 214 of the second row are also staggered and not aligned. Similarly, for the second radiation array 220, the first radiating element 221 of the first row and the first radiating element 223 of the second row are staggered and not aligned. Correspondingly, the second radiating element 222 of the first row and the second radiating element 224 of the second row are also staggered and not aligned. In addition, as shown in FIG. 2, the first radiation array 210 and the second radiation array 220 are symmetric about a symmetry axis. For example, the symmetry axis can be a dividing line between the first radiation array 210 and the second radiation array 220.

FIG. 3 is a schematic structural diagram of a radiation array 310 according to some embodiments of the present disclosure. As shown in FIG. 3, the radiation array 310 of the present disclosure includes at least a first radiating element row and a second radiating element row. The first radiating element row includes a first radiating element 311 and a second radiating element 312 arranged in a row along the first direction (e.g., a horizontal direction in FIG. 3). The second radiating element row includes a third radiating element 313 and a fourth radiating element 314 arranged in a row along the first direction (e.g., the horizontal direction in FIG. 3). The first radiating element row and the second radiating element row are arranged along a second direction (e.g., a vertical direction in FIG. 3) perpendicular to the first direction. A center projection of the first radiating element 311, a center projection of the third radiating element 313, a center projection of the second radiating element 312, and a center projection of the fourth radiating element 314 are arranged from left to right in sequence on a plane perpendicular to the second direction (e.g., the vertical direction in FIG. 3). That is, the first radiating element row and the second radiating element row in FIG. 3 are not aligned but staggered. In addition, as shown in FIG. 3, the radiation array 310 includes eight radiating element rows. Each radiating element row includes two radiating elements. In some embodiments, the third radiating element row includes a radiating element 315 and a radiating element 316. The fourth radiating element row includes a radiating element 317 and a radiating element 318. The fifth radiating element row includes a radiating element 311′ and a radiating element 312′. The sixth radiating element row includes a radiating element 313′ and a radiating element 314′. The seventh radiating element row includes a radiating element 315′ and a radiating element 316′. The eighth radiating element row includes a radiating element 317′ and a radiating element 318′. As shown in FIG. 3, the eight radiating element rows are staggered along the second direction. That is, the first radiating element row and the second radiating element row are staggered, the second radiating element row and the third radiating element row are staggered, the third radiating element row and the fourth radiating element row are staggered, and so on. Such an arrangement can also be used in other embodiments of the present disclosure. That is, along the second direction, a radiating element of the second row can be between two neighboring radiating elements of the first row. In some other embodiments, along the second direction, two radiating elements of the first row and the radiating elements of the second row are arranged alternatively in sequence. That is, in other embodiments of the present disclosure, the first radiation array can include four, six, or eight radiating element rows.

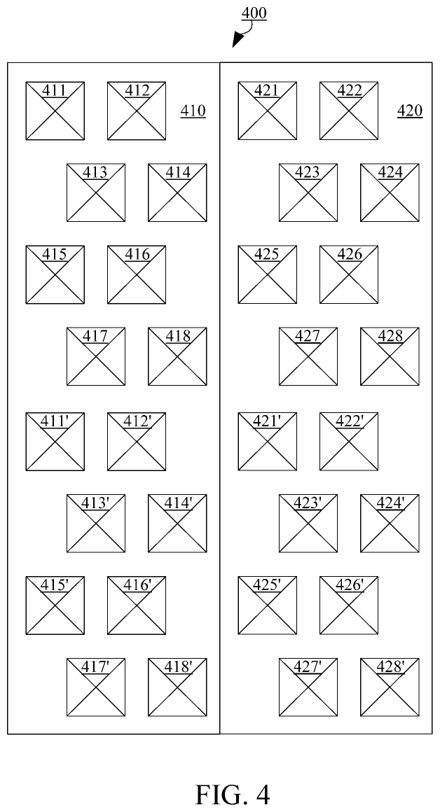

Radiating element arrays 310 of FIG. 3 forms a radiation array group of the dual-beam antenna. FIG. 4 is a schematic structural diagram of a radiation array group 400 according to some embodiments of the present disclosure. As shown in FIG. 4, the radiation array 410 of the present disclosure includes eight radiating element rows. A first radiating element row on the left side includes a first radiating element 411 and a second radiating element 412 arranged in a row along the first direction (e.g., the horizontal direction of FIG. 4). A second radiating element row on the left side includes a third radiating element 413 and a fourth radiating element 414 arranged in a row along the first direction (e.g., the horizontal direction of FIG. 4). The first radiating element row and the second radiating element row are arranged along the second direction (e.g., the vertical direction of FIG. 4) perpendicular to the first direction. A center projection of the first radiating element 411, a center projection of the third radiating element 413, a center projection of the second radiating element 412, and a center projection of the fourth radiating element 414 are arranged from left to right in sequence on the plane perpendicular to the second direction (e.g., the vertical direction of FIG. 4). That is, the first radiating element row and the second radiating element row of FIG. 4 are not aligned but staggered. In addition, as shown in FIG. 4, the radiation array 410 also includes additional six radiating element rows. Each radiating element row includes two radiating elements. In some embodiments, the third radiating element row includes a radiating element 415 and a radiating element 416. The fourth radiating element row includes a radiating element 417 and a radiating element 418. The fifth radiating element row includes a radiating element 411′ and a radiating element 412′. The sixth radiating element row includes a radiating element 413′ and a radiating element 414′. The seventh radiating element row includes a radiating element 415′ and a radiating element 416′. The eighth radiating element row includes a radiating element 417′ and a radiating element 418′.

In addition, as shown in FIG. 4, in embodiments of the present disclosure, the radiation array 420 of the present disclosure includes eight radiating element rows. The first radiating element row on the right side includes a first radiating element 421 and a second radiating element 422 arranged in a row along the first direction (e.g., the horizontal direction in FIG. 4). The second radiating element row on the right side includes a third radiating element 423 and a fourth radiating element 424 arranged in a row along the first direction (e.g., the horizontal direction in FIG. 4). The first radiating element row and the second radiating element row are arranged along the second direction perpendicular to the first direction (e.g., the vertical direction in FIG. 4). A center projection of the first radiating element 421, a center projection of the third radiating element 423, a center projection of the second radiating element 422, and a center projection of the fourth radiating element 424 are arranged from left to right in sequence on the plane perpendicular to the second direction (e.g., the vertical direction in FIG. 4). That is, the first radiating element row and the second radiating element row in FIG. 4 are not aligned but staggered. In addition, as shown in FIG. 4, the radiation array 420 also includes other six radiating element rows. Each radiating element row includes two radiating elements. In some embodiments, the third radiating element row includes a radiating element 425 and a radiating element 426. The fourth radiating element row includes a radiating element 427 and a radiating element 428. The fifth radiating element row includes a radiating element 421′ and a radiating element 422′. The sixth radiating element row includes a radiating element 423′ and a radiating element 424′. The seventh radiating element row includes a radiating element 425′ and a radiating element 426′. The eighth radiating element row includes a radiating element 427′ and a radiating element 428′.

As shown in FIG. 4, the radiation array 410 on the left side and the radiation array 420 on the right side have the same structure. Correspondingly, as the difference of FIG. 2 relative to FIG. 1, the radiation array 420 on the right side in FIG. 4 can be, for example, mirrored and rotated 180°. Thus, after being mirrored and rotated, the radiation array 420 on the right side and the radiation array 410 on the left side can have a structure symmetrical about the center dividing line.

No matter in the radiation array 410 on the left side or the radiation array 420 on the right side, the first radiating element row and the second radiating element row can be staggered. The third radiating element row and the fourth radiating element row can be staggered. The fifth radiating element row and the sixth radiating element row can be staggered. The seventh radiating element row and the eighth radiating element row can be staggered.

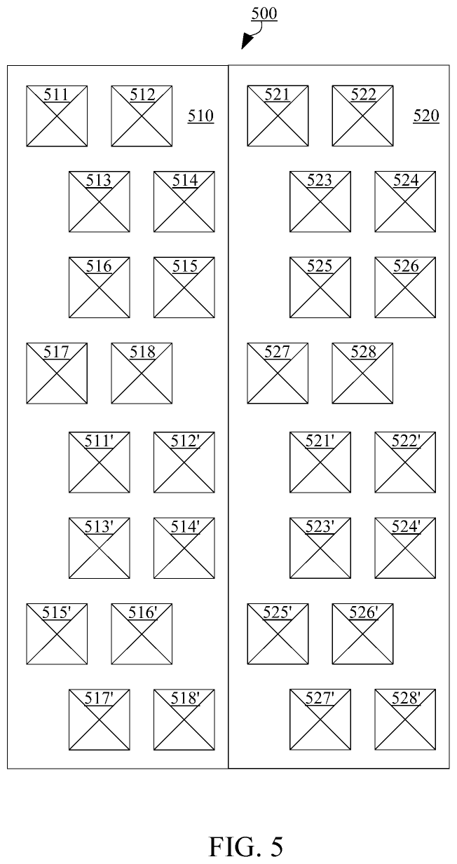

FIG. 5 is a schematic structural diagram of a radiation array group 500 according to some embodiments of the present disclosure. As shown in FIG. 5, the radiation array 510 of the present disclosure includes eight radiating element rows. The first radiating element row on the left side includes a first radiating element 511 and a second radiating element 512 arranged in a row along the first direction (e.g., the horizontal direction in FIG. 5). The second radiating element row on the left side includes a third radiating element 513 and the fourth radiating element 514 arranged in a row along the first direction (e.g., the horizontal direction in FIG. 5). The first radiating element row and the second radiating element row are arranged along the second direction (e.g., the vertical direction in FIG. 5) perpendicular to the first direction. A center projection of the first radiating element 511, a center projection of the third radiating element 513, a center projection of the second radiating element 512, and a center projection of the fourth radiating element 514 are arranged from left to right in sequence on the plane perpendicular to the second direction (e.g., the vertical direction in FIG. 5). That is, in FIG. 5, the first radiating element row and the second radiating element row are not aligned but staggered. In addition, as shown in FIG. 5, the radiation array 510 further includes other six radiating element rows. Each radiating element row includes two radiating elements. In some embodiments, the third radiating element includes a radiating element 515 and a radiating element 516. The fourth radiating element includes a radiating element 517 and a radiating element 518. The fifth radiating element includes a radiating element 511′ and a radiating element 512′. The sixth radiating element includes a radiating element 513′ and a radiating element 514′. The seventh radiating element includes a radiating element 515′ and a radiating element 516′. The eighth radiating element includes a radiating element 517′ and a radiating element 518′.

In addition, as shown in FIG. 5, in some embodiments, the radiation array 520 of the present disclosure includes eight radiating element rows. The first radiating element row on the right side includes a first radiating element 521 and a second radiating element 522 arranged in a row along the first direction (e.g., the horizontal direction in FIG. 5). The second radiating element row on the right side includes a third radiating element 523 and a fourth radiating element 524 arranged in a row along the first direction (e.g., the horizontal direction in FIG. 5). The first radiating element row and the second radiating element row are arranged along the second direction (e.g., the vertical direction in FIG. 5) perpendicular to the first direction. A center projection of the first radiating element 521, a center projection of the third radiating element 523, a center projection of the second radiating element 522, and a center projection of the fourth radiating element 524 are arranged from left to right in sequence on the plane perpendicular to the second direction (e.g., the vertical direction in FIG. 5). That is, in FIG. 5, the first radiating element row and the second radiating element row are not aligned but staggered. In addition, as shown in FIG. 5, the radiation array 520 further includes other six radiating element rows. Each radiating element row includes two radiating elements. The third radiating element row includes a radiating element 525 and a radiating element 526. The fourth radiating element row includes a radiating element 527 and a radiating element 528. The fifth radiating element row includes a radiating element 521′ and a radiating element 522′. The sixth radiating element row includes a radiating element 523′ and a radiating element 524′. The seventh radiating element row includes a radiating element 525′ and a radiating element 526′. The eighth radiating element row includes a radiating element 527′ and a radiating element 528′.

As shown in FIG. 5, the radiation array 510 on the left side and the radiation array 520 on the right side have the same structure. Correspondingly, as the difference between FIG. 2 and FIG. 1, the radiation array 520 on the right side in FIG. 5 can also be mirrored and rotated 180º. Thus, after being mirrored and rotated, the radiation array 520 on the right side and the radiation array 510 on the left side are symmetrical about the center dividing line.

No matter for the radiation array 510 on the left side or the radiation array 520 on the right side, the first radiating element row and the second radiating element row can be staggered. The third radiating element row and the second radiating element row can be aligned with each other. The fourth radiating element row and the first radiating element row can be aligned. The fifth radiating element row and the sixth radiating element row can be staggered with the fourth radiating element row, and the fifth radiating element row and the sixth radiating element row can be aligned. The seventh radiating element row and the first radiating element row can be aligned. The eighth radiating element row and the sixth radiating element row can be aligned. In summary, the first radiating element row and the second radiating element can be staggered. The second radiating element row and the third radiating element row can be aligned.

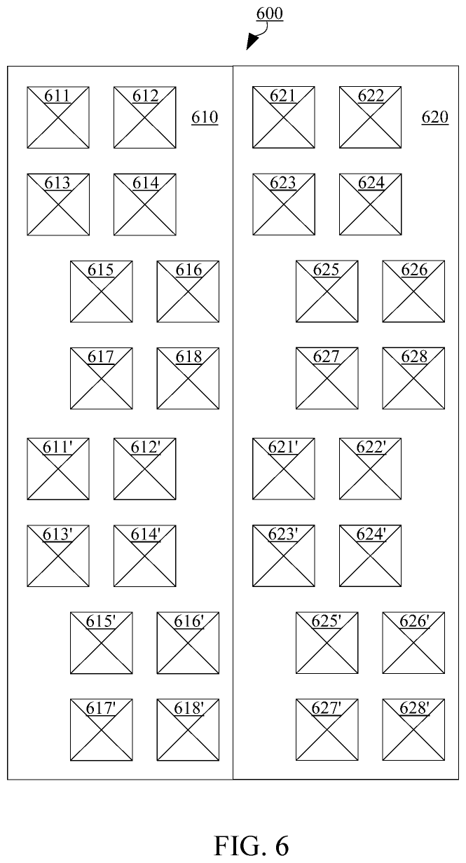

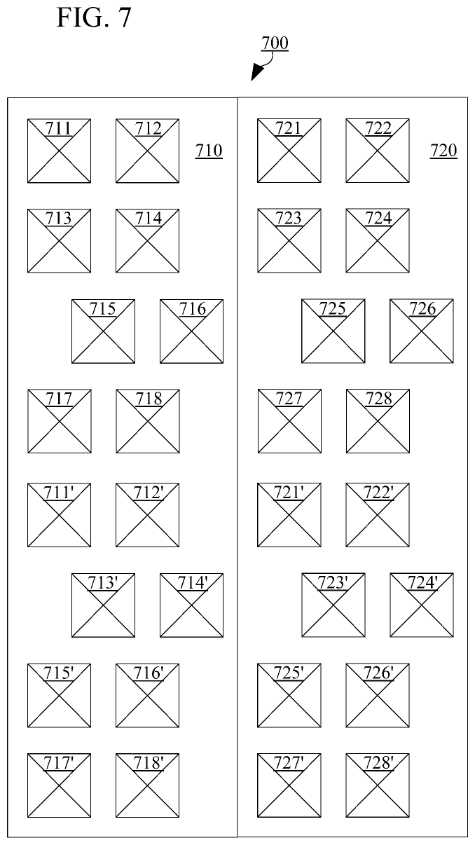

FIG. 6 is a schematic structural diagram of a radiation array group 600 according to some embodiments of the present disclosure. As shown in FIG. 6, the radiation array 610 of the present disclosure includes eight radiating element rows. The first radiating element row on the left includes a first radiating element 611 and a second radiating element 612 arranged in a row along the first direction (e.g., the horizontal direction in FIG. 6). The second radiating element row on the left side includes a third radiating element 613 and a fourth radiating element 614 arranged in a row along the first direction (the horizontal direction in FIG. 6). The first radiating element row and the second radiating element row can be arranged along the second direction perpendicular to the first direction (e.g., the vertical direction in FIG. 6). A center projection of the first radiating element 611, a center projection of the third radiating element 613, a center projection of the second radiating element 612, and a center projection of the fourth radiating element 614 are arranged from left to right in sequence on the plane perpendicular to the second direction (the vertical direction in FIG. 6). That is, the first radiating element row and the second radiating element row in FIG. 6 are not aligned but staggered. In addition, as shown in FIG. 6, the radiation array 610 further includes other six radiating element rows. Each radiating element row includes two radiating elements. In some embodiments, the third radiating element row includes a radiating element 615 and a radiating element 616. The fourth radiating element row includes a radiating element 617 and a radiating element 618. The fifth radiating element row includes a radiating element 611′ and a radiating element 612′. The sixth radiating element row includes a radiating element 613′ and a radiating element 614′. The seventh radiating element row includes a radiating element 615′ and a radiating element 616′. The eighth radiating element row includes a radiating element 617′ and a radiating element 618′.

In addition, in some embodiments, as shown in FIG. 6, the radiation array 620 of the present disclosure includes eight radiating element rows. The first radiating element row on the right side includes a first radiating element 621 and a second radiating element 622 arranged in a row along the first direction (e.g., the horizontal direction in FIG. 6). The second radiating element row on the right side includes a third radiating element 623 and a fourth radiating element 624 arranged in a row along the first direction (e.g., the horizontal direction in FIG. 6). The first radiating element row and the second radiating element row are arranged along the second direction (e.g., the vertical direction in FIG. 6) perpendicular to the first direction. A center projection of the first radiating element 621, a center projection of the third radiating element 623, a center projection of the second radiating element 622, and a center projection of the fourth radiating element 624 are arranged from left to right in sequence on the plane perpendicular to the second direction (e.g., the vertical direction in FIG. 6). That is, the first radiating element row and the second radiating element row are not staggered but aligned with each other. In addition, as shown in FIG. 6, the radiation array 620 further includes other six radiating element rows. Each radiating element row includes two radiating elements. In some embodiments, the third radiating element row includes a radiating element 625 and a radiating element 626. The fourth radiating element row includes a radiating element 627 and a radiating element 628. The fifth radiating element row includes a radiating element 621′ and a radiating element 622′. The sixth radiating element row includes a radiating element 623′ and a radiating element 624′. The seventh radiating element row includes a radiating element 625′ and a radiating element 626′. The eighth radiating element row includes a radiating element 627′ and a radiating element 628′.

As shown in FIG. 6, the radiation array 610 on the left and the radiation array 620 on the right have the same structure. Correspondingly, as the difference between FIG. 2 and FIG. 1, the radiation array 620 on the right side in FIG. 6 can also be mirrored and flipped 180°. Thus, after the flipping, the radiation array 620 on the right side and the radiation array 610 on the left side have a symmetrical structure about the center dividing line.

No matter for the radiation array 610 on the left side or the radiation array 620 on the right side, the first radiating element row and the second radiating element row are aligned with each other. The third radiating element row is staggered with the second radiating element row but is aligned with the fourth radiating element. The fifth radiating element row and the sixth radiating element row are aligned with the first radiating element row. The seventh radiating element row and the eighth radiating element row can be aligned with the third radiating element row. In summary, the first radiating element row and the second radiating element row can be aligned with each other. The third radiating element and the fourth radiating element row can be aligned with each other. The second radiating element row and the third radiating element row are staggered.

FIG. 7 is a schematic structural diagram of a radiation array group 700 according to some embodiments of the present disclosure. As shown in FIG. 7, the radiation array 710 of the present disclosure includes eight radiating element rows. The first radiating element row on the left side includes a radiating element 711 and a radiating element 712 arranged in a row along the first direction (e.g., the horizontal direction in FIG. 7). The second radiating element row on the left side includes a third radiating element 713 and a fourth radiating element 714 arranged in a row along the first direction (the horizontal direction in FIG. 7). The first radiating element row and the second radiating element row can be arranged along the second direction perpendicular to the first direction (e.g., the vertical direction in FIG. 7). A center projection of the first radiating element 711, a center projection of the third radiating element 713, a center projection of the second radiating element 712, and a center projection of the fourth radiating element 714 are arranged from left to right in sequence on the plane perpendicular to the second direction (the vertical direction in FIG. 7). That is, the first radiating element row and the second radiating element row in FIG. 7 are not staggered but aligned. In addition, as shown in FIG. 7, the radiation array 710 further includes other six radiating element rows. Each radiating element row includes two radiating elements. In some embodiments, the third radiating element row includes a radiating element 715 and a radiating element 716. The fourth radiating element row includes a radiating element 717 and a radiating element 718. The fifth radiating element row includes a radiating element 711′ and a radiating element 712′. The sixth radiating element row includes a radiating element 713′ and a radiating element 714′. The seventh radiating element row includes a radiating element 715′ and a radiating element 716′. The eighth radiating element row includes a radiating element 717′ and a radiating element 718′.

In addition, in some embodiments, as shown in FIG. 7, the radiation array 720 of the present disclosure includes eight radiating element rows. The first radiating element row on the right side includes a first radiating element 721 and a second radiating element 722 arranged in a row along the first direction (e.g., the horizontal direction in FIG. 7). The second radiating element row on the right side includes a third radiating element 723 and a fourth radiating element 724 arranged in a row along the first direction (e.g., the horizontal direction in FIG. 7). The first radiating element row and the second radiating element row are arranged along the second direction (e.g., the vertical direction in FIG. 7) perpendicular to the first direction. A center projection of the first radiating element 721, a center projection of the third radiating element 723, a center projection of the second radiating element 722, and a center projection of the fourth radiating element 724 are arranged from left to right in sequence on the plane perpendicular to the second direction (e.g., the vertical direction in FIG. 7). That is, the first radiating element row and the second radiating element row are not staggered but aligned with each other. In addition, as shown in FIG. 7, the radiation array 720 further includes other six radiating element rows. Each radiating element row includes two radiating elements. In some embodiments, the third radiating element row includes a radiating element 725 and a radiating element 726. The fourth radiating element row includes a radiating element 727 and a radiating element 728. The fifth radiating element row includes a radiating element 721′ and a radiating element 722′. The sixth radiating element row includes a radiating element 723′ and a radiating element 724′. The seventh radiating element row includes a radiating element 725′ and a radiating element 726′. The eighth radiating element row includes a radiating element 727′ and a radiating element 728′.

As shown in FIG. 7, the radiation array 710 on the left and the radiation array 720 on the right have the same structure. Correspondingly, as the difference between FIG. 2 and FIG. 1, the radiation array 720 on the right side in FIG. 7 can also be mirrored and flipped 180°. Thus, after the flipping, the radiation array 720 on the right side and the radiation array 710 on the left side have a symmetrical structure about the center dividing line.

No matter for the radiation array 710 on the left side or the radiation array 720 on the right side, the first radiating element row and the second radiating element row are aligned with each other. The third radiating element row is staggered with the second radiating element row. The fourth radiating element and the fifth radiating element row are aligned with the first radiating element row. The sixth radiating element row is aligned with the third radiating element row. The seventh radiating element row and the eighth radiating element row are aligned with the first radiating element row. In summary, the first radiating element row and the second radiating element row are aligned with each other. The second radiating element and the third radiating element row are staggered.

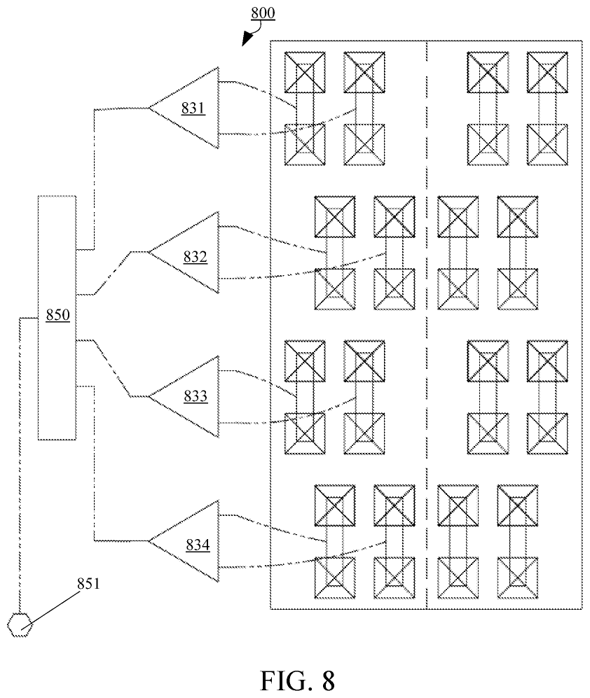

FIG. 8 is a schematic diagram showing the wiring of the radiation array group 600 in FIG. 6 according to some embodiments of the present disclosure. As shown in FIG. 8, the first radiating element in the first row and the first radiating element in the second row on the left side are electrically connected and connected to a terminal of a first power divider 831, while the second radiating element in the first row and the second radiating element in the second row are electrically connected and connected to another terminal of the first power divider 831. Similarly, the first radiating element in the third row and the first radiating element in the fourth row are electrically connected and then connected to a terminal of a second power divider 832, while the second radiating element in the third row and the second radiating element in the fourth row on the left side are electrically connected and then connected to another terminal of the second power divider 832. The first radiating element in the fifth row and the first radiating element in the sixth row on the left side are electrically connected and then connected to a terminal of a third power divider 833, while the second radiating element in the fifth row and the second radiating element in the sixth row on the left side are electrically connected and then connected to another terminal of the third power divider 833. The first radiating element in the seventh row and the first radiating element in the eighth row on the left side are electrically connected and then connected to a terminal of a fourth power divider 834, while the second radiating element in the seventh row and the second radiating element in the eighth row on the left side are electrically connected and then connected to another terminal of the fourth power divider 834. Input terminals of the four power dividers are connected to output terminals of a phase shifter 850. The input terminal 851 of the phase shifter 850 can be configured to input a signal.

As shown in FIG. 8, since a distance between radiating elements in a same row is increased, matching difficulty between the radiating elements is reduced compared to the three-column design of the existing technology. Meanwhile, the radiation performance of each radiating element can be increased. Moreover, radiating elements of some rows are staggered to effectively reduce the far side lobes caused by the parallel arrangement. That is, the manufacturing cost can be reduced according to the radiation array or the radiation array group of the present disclosure, and the overall performance (e.g., gain and side lobe) can be also improved. A distance between center points of two radiating elements can range from 0.6 to 0.85 of a wavelength. A distance between a center point of the second radiating element in the first row and a center point of the first radiating element in the second row can range from 0.25 to 0.45 of the wavelength. Correspondingly, a width of a reflection plate of a radiation array can be fixed, ranging from 1.5 to 2.3 wavelengths. With such a radiation array, the radiation efficiency of the radiation array can be increased, the beam isolation can be improved, and the number of radiating elements and the manufacturing cost can be reduced. Although not shown in the accompanying drawings, in embodiments of the present disclosure, the radiation array group can further include a first reflection plate and a second reflection plate. The first radiation array can be fixed at the first reflection plate, and the second radiation array can be fixed at the second reflection plate. The first reflection plate and the second reflection plate can have an included angle to form a stable beam radiation direction.

Furthermore, a third aspect of the present disclosure provides a dual-beam antenna. The dual-beam antenna includes the radiation array group according to the first aspect of the present disclosure, the radiation array according to the second aspect of the present disclosure, and a power splitter plate connected to the radiation array group.

In summary, in the radiation array group of the present disclosure or the radiation array of the present disclosure, the number of radiating elements in each row is reduced, and the distance between the radiating elements in the same row is increased. Thus, the technical problem that the radiation efficiency under the tight coupling status is poor can be improved, and the manufacturing cost of the radiation array can be reduced. Meanwhile, by staggering the radiating elements of different rows, the high sidelobe problem caused by the conventional linear distribution of two-column units can be improved, which achieves high beam isolation and good horizontal coverage.

Although various embodiments of the present disclosure have been described, different modifications and changes, which are apparent to those skilled in the art, can be performed to realize one or some advantages of the present disclosure without departing from the spirit and scope of the present disclosure. For those skilled in the art, members performing the same function can be replaced. The features described according to a specific drawing can be combined with features of other drawings, even in the situation that the combination of the features is not described. In addition, the method of the present disclosure can be implemented in a software method instructed by a processor or in a combination of software and hardware to obtain the same result. The modifications to the solutions of the present disclosure are within the scope of the appended claims.

What is claimed is:

1. A radiation array group for a dual-beam antenna comprising:
a first radiation array configured to form a first beam; and
a second radiation array configured to form a second beam;
wherein:
either one of the first radiation array and the second radiation array includes at least two radiating element rows;
each radiating element row of the at least two radiating element rows includes two radiating elements; and
the at least two radiating element rows are not always aligned with each other.

2. The radiation array group according to claim 1, wherein the first radiation array and the second radiation array have a same structure.

3. The radiation array group according to claim 1, wherein the first radiation array and the second radiation array are axially symmetrical about an axis of symmetry.

4. The radiation array group according to claim 1, wherein the first radiation array includes four, six, or eight radiating element rows.

5. The radiation array group according to claim 4, wherein a first radiating element row and a second radiating element row of the first radiation array are staggered.

6. The radiation array group according to claim 4, wherein:
a first radiating element row and a second radiating element row of the first radiation array are aligned with each other;
a third radiating element row and a fourth radiating element row of the first radiation array are aligned with each other; and
the second radiating element row and the third radiating element row are staggered.

7. The radiation array group according to claim 4, wherein:
a first radiating element row and a second radiating element row of the first radiation array are staggered; and
the second radiating element row and a third radiating element row of the first radiation array are aligned with each other.

8. The radiation array group according to claim 4, wherein:
a first radiating element row and a second radiating element row of the first radiation array are aligned with each other; and
the second radiating element row and a third radiating element row are staggered.

9. The radiation array group according to claim 1, wherein:
two radiating elements included in each radiating element row of the at least two radiating element rows are connected through a power divider to form a sub-array.

10. The radiation array group according to claim 9, wherein sub-arrays in different rows are connected through a power divider or a phase shifter to form the first radiation array or the second radiation array.

11. The radiation array group according to claim 1, further comprising:
a first reflection plate, the first radiation array being fixed at the first reflection plate; and
a second reflection plate, the second radiation array being fixed at the second reflection plate;
wherein the first reflection plate and the second reflection plate have an angle.

12. A radiation array comprising:
at least one first radiating element row including a first element and a second element arranged in a row along a first direction;
at least one second radiating element row including a third element and a fourth element arranged in a row along the first direction;
wherein:
the at least one first radiating element row and the at least one second radiating element row are arranged along a second direction perpendicular to the first direction; and
a center projection of the first element, a center projection of the third element, a center projection of the second element, and a center projection of a fourth element are arranged in sequence on a plane perpendicular to the second direction.

13. The radiation array according to claim 12, wherein the first radiating element row and the second radiating element row are arranged at intervals along the second direction.

14. The radiation array according to claim 12, wherein along the second direction, a radiating element of the second row is between two radiating elements in the first row.

15. The radiation array according to claim 12, wherein along the second direction, two radiating elements of the first row and two radiating elements of the second row are arranged at intervals in sequence.

16. A dual-beam antenna comprising:
a radiation array group, comprising:
a first radiation array configured to form a first beam; and
a second radiation array configured to form a second beam; and
a power divider connected to the radiation array group,
wherein:
either one of the first radiation array and the second radiation array includes at least two radiating element rows;
each radiating element row of the at least two radiating element rows includes two radiating elements; and
the at least two radiating element rows are not always aligned with each other.

17. The dual-beam antenna according to claim 16, wherein the first radiation array and the second radiation array have a same structure.

18. The dual-beam antenna according to claim 16, wherein the first radiation array and the second radiation array are axially symmetrical about an axis of symmetry.

19. The dual-beam antenna according to claim 16, wherein the first radiation array includes four, six, or eight radiating element rows.

20. The dual-beam antenna according to claim 19, wherein a first radiating element row and a second radiating element row of the first radiation array are staggered.
